(19) United States
(12) Patent Application Publication
(10) Pub. No.: US 2009/0146430 A1
(43) Pub. Date: Jun. 11, 2009

(54) Tidal/water current electrical generating system

(76) Inventor: Walter Edmond Sear, New York, NY (US)

Correspondence Address: WALTER EDMOND SEAR, 353 WEST 48TH STREET, NEW YORK, NY, 10036, US

(21) Appl. No.: 12/001,038

(22) Filed: Dec. 10, 2007

(51) Int. Cl. F03B 13/10

(52) U.S. Cl. 290/54

(57) ABSTRACT

An integral system to utilize the flow of water, fresh or ocean, to generate electric power from river flow or tidal currents, consisting of three parts, an especially designed impeller to convert the water flow into rotary mechanical motion, a totally encapsulated alternator/generator, and a pedestal upon which the entire device is mounted which is set into the sea bed or river bed and which is fitted with a swivel bearing which allows a limited rotation of the alternator/impeller assembly, and with fins to keep the impeller pointed into the existing current and which also serve as heatsinks for the alternator/generator.

### BACKGROUND OF THE INVENTION

References cited:

### U.S. Patent Documents

| | | |
|---|---|---|
| 7,199,484 B2 | Apr. 3, 2007 | Brashears |
| 7,116,005 B2 | Oct. 3, 2006 | Corcoran, III |
| 4,026,587 | May 31, 1977 | Hultman et al. |
| 5,043,592 | Aug. 27, 1991 | Hochstrasser |
| 5,499,013 | Mar. 12, 1996 | Konotchick |
| 5,936,321 | Aug. 10, 1999 | Kameoka et al. |
| 5,929,611 | Jul. 27, 1999 | Scott et al. |
| US 2005/0285407 A1 | Dec. 29, 2005 | Davis et al. |

Heretofore, there have been a variety of proposals involving the use of river flow or tidal flow of natural waterways to provide the power source to be converted into rotary energy to operate an electrical generating device. These have been proven to be impractical because of high maintenance due to the hostile environment of salt water of even fresh water, environmental problems and general price to output inefficiencies. The use of propellers rather than impellers has created structural problems with the propellers, which are subject to structural failure due to the mechanical stress and the flotsam and jetsam which is floating in the water. They also might create environmental problems because of the potential damage to fish and other aquatic life. Propellers require a large draft and might also present a hazard to navigation as well as to people who may be swimming in the water. In tidal applications, the propellers must be designed to operate bi-directionally to accommodate the changes in the flowing of the tides. This generally leads to a less efficient design. The alternator/generator, which is the most expensive part of the system, must have a drive shaft extending from the propeller into the generating device, which is subject to leakage around the seals, resulting in damage to the generating device. The subsequent ridged mounting of the entire device to its mooring makes it less efficient as far as accommodating variations in the flow of water and it makes the entire mechanism more subject to damage from debris in the water, including large fish.

### BRIEF DESCRIPTION OF THE DRAWINGS

These drawings are presented to further clarify the written description of the invention.

FIG. 1 is an overall depiction of the invention and its major components in situ.

FIG. 2 is an end view of the impeller blade design.

FIG. 3 is a side view of the impeller showing the increasing depth of the blades.

FIG. 4 is a schematic side view of the alternator/generator.

FIG. 5 is a schematic of the changes in magnetic flux within the alternator/generator.

FIG. 6 is a description of the possible arrangements of the permanent magnets, both in radial and axial view.

FIG. 7 is an axial view of the generating device showing possible arrangements of the stator windings.

FIG. 8 is a radial and axial view of the generating device showing a different configuration of the coils and pole pieces.

FIG. 9 is a radial view of a bi-wound alternator/generator with coils wound around both stator and rotor permanent magnets.

FIG. 10 is a cross sectional view of the bi-wound generating device.

### SUMMARY OF THE PRESENT INVENTION

The present invention is designed to overcome these difficulties by providing apparatus and systems to provide an economic, safe and efficient system for the generation of electrical power. Because of the design of the impeller, significantly less diameter is needed in comparison to a propeller of equal torque. The draft will be far less, allowing the device to be used in much shallower water.

The present invention is divided into three parts: 1) an efficient water turbine which is an impeller rather than a propeller, 2) totally sealed generating unit of a conventional or unique design, and 3) a pedestal mount with a swivel bearing upon which the entire device is mounted.

The impeller is designed as a conical device with a semi-hemispherical front hub at its center. Radiating backward from this hub, axial to the flow of water, almost parallel vanes increase in their angle to the flow of water as the diameter of the cone increases, terminating in an almost 90 degree angle to the flow as they approach the base of the cone. The thickness of the vane walls increases as the area pressure increases, for structural reasons. The depth of the vanes from tip to base is also increased to provide a greater and greater surface area to the flow of the water. A center shaft is affixed to the impeller with suitable bearings and seals to sustain the impeller's rotation.

At the cone base end of this shaft and within the enclosure of the bearing mount, is affixed one disc of a magnetic clutch, such as the samarium-cobalt, neodymium-iron-boron or other high fluxivity magnets.

The entire impeller and bearing mount are enclosed in a screen of a suitably durable material, such as stainless steel. This acts to deflect any solid materials floating in the water as well as a safety device for passing fish and human swimmers.

The second part of the device consists of an alternator/generator. Although conventional alternator/generators may be used, a high torque and low speed alternator is preferable for this patent. This invention includes a new design for the alternator/generator. In conventional alternators, the pole pieces usually consist of a laminated iron structure around which the wire coils are wound. The rotating element (“rotor”), which consists of permanent magnets, induces a magnetic field, concentrated by the iron core in the stator, which induces electrical energy into the stator coils. The rotor magnets of opposite polarity then pass the stator and reverse the magnetic field, inducing an electric current in the opposite direction in the stator coils.

This results in various hysteresis and eddy current losses, induced by the permanent magnets on the rotating armature (rotor), resulting in less of a magnetic field crossing the generating coils and hence, a reduction in the electrical output.

In the present invention, these iron pole pieces are replaced by high fluxivity magnets, often referred to as ‘super magnets’ and ‘rare earth’ magnets. The generator stator windings are wound directly around these magnets. In a static position, a stationary magnetic field envelops the windings and no current is generated. As the high coercivity permanent magnets on the rotor is powered by the impeller into rotation, the magnetic field of the stator is first deflected by the north pole to north pole configuration and then as the rotor rotates, the south pole approaches the field magnet's north pole and the magnetic flux is drawn toward the end of the magnet creating electrical energy from the resulting perturbation of the magnetic field around the stator magnet and its coil.

Because of the two magnets involved, one in the stator and one in the rotor, greater magnetic flux is generated and hence, greater electrical output is obtained. These magnetic units, both in the stator and the rotor, can be compounded up to the limits of the physical space. By placing the rotor magnets axially, two ranks of stator magnets can face the north and south poles of the rotor to produce sine waves 180 degrees out of phase, or by placing the stator magnets one segment apart from the first rank of stators, a doubling of the voltage output can be produced, in phase. This, together with the decrease or elimination of the hysteresis losses, will produce a more efficient alternator/generator.

As a farther varient of this concept, coils could also be wound around the rotor magnets. Their magnetic flux would also be forced into osciillation, the same as the stator wound magnets, Additional electrical energy would be produced. This would require the addition of commutators and brushes to transfer the electrical energy into the load.

Since alternators are potentially motors and conversely all motors are potentially alternators, the above concept of an oscillating magnetic field is reserved for motors operating on the same principal.

The rotor shaft is mounted on conventional bearings. Affixed onto the end of this shaft, the second disc of the magnetic clutch is attached in alignment to the magnetic clutch disc attached to the impeller shaft. A thin non-magnetic membrane is placed between the two magnetic clutch discs to create a water-tight seal, both to the generator housing and the impeller housing.

The entire alternator/generator is enclosed in a waterproof container with a threaded end and end cap at the downstream end which can be removed on dry land for servicing.

Axially, along the entire length of this waterproof container, heat conducting fins are attached. These fins serve two purposes; first to keep the entire device pointed into the flow of water, and, secondly, to dissipate the heat generated in the alternator/generating housing. This heat is generated by the I square R losses, eddy currents and hysterises losses and friction. The fins will serve the same purpose as elephant ears—to provide more area for heat dissipation into the surrounding water.

The present embodiment provides for a hermetically sealed alternator/generator chamber. As an added precaution against air and water vapor corrosion, as an option, the alternator/generator chamber could be filled with dry nitrogen or inert gasses before being sealed. A desiccant could also be inserted to absorb any water vapor left in the housing. All of these provision would apply equally should a conventional generating device be used.

Mechanical connection from the generating pod to the impeller assembly is provided by studs extending from the front of the generating pod, and the waterproof alternator/generating housing could be sealed to this flange. The protective screen could also be attached to these mountings.

A suitable waterproof electrical connection is provided, such as a commutator or a simple flexible waterproof cable to transmit the electrical energy to the shore where it could be rectified into D.C. and reconverted to the electrical grid requirements.

The third part of the device consists of a suitable mount, which is firmly attached to the ocean or river bed. This could consist of a piling or a suitable metal mount securely attached to the river or ocean bed.

The generating device is equipped with a swivel bearing which allows the generating device with the impeller assembly attached, to rotate through approximately 210 degrees on this mount. Stops are provided to prevent the device from rotating a full 360 degrees, thus reducing the strain on the flexible electrical cable to the shore. This is also to accommodate the changing of the tides. By allowing the device, due to the fins on the generator housing, to always point into the flow of the water, some additional electrical energy can be generated even during a change of tides. It also provides additional protection against any radical changes in the water flow by adjusting to these changes.

### DETAILED DESCRIPTION OF THE INVENTION

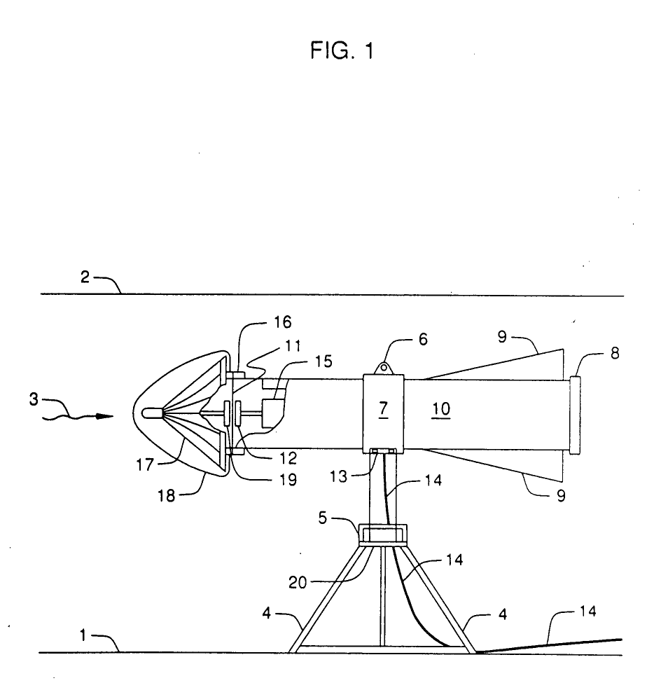

FIG. 1 is an overall description of the invention. #1 in the drawing represents the river bed upon which the invention is placed. #2 depicts the surface of the body of water, below which the device is placed. #3 depicts the direction of flow of the body of water. #4 depicts the mechanical mounting of the device, which can be a pylon or a pile driven into the bed of the body of water. #5 is a thrust or other suitable bearing which allows the upper structure of the alternator/generator with the attached impeller assembly to rotate freely. This is restricted by stops to limit the amount of rotation, thereby reducing the strain on the flexible power cable leading to shore.

#6 is a launching ring to facilitate the lowering and raising of the device into and out of the water. #7 is a mounting saddle which mechanically attaches the base pedestal to the generating pod. #8 is the end cap to the waterproof housing of the generating device to allow access for maintenance when the invention is raised out of the water. #9 is a single or combination of fins which will keep the invention pointed into the flow of water and which acts as heat sinks. #10 is a waterproof contained for the generating device. #11 is a thin, non-magnetic end seal, attached to the waterproof container. #12 is one disc of the magnetic clutch, attached to the rotor shaft of the generating device. #13 is a commutator to transfer the electrical energy from the generating device to a flexible cable.

#14 is a suitable waterproof cable to transfer the electrical energy from the invention to the shore distribution facility. #15 is the alternator/generator. #16 is the mounting flange on the impeller housing. #17 is the impeller, described below. #18 is a protective screen around the entire impeller assembly. #19 is the second disc of the magnetic clutch attached to the impeller axle. #20 is a waterproof seal at the base of the generator pod to protect the thrust bearing and generator pod.

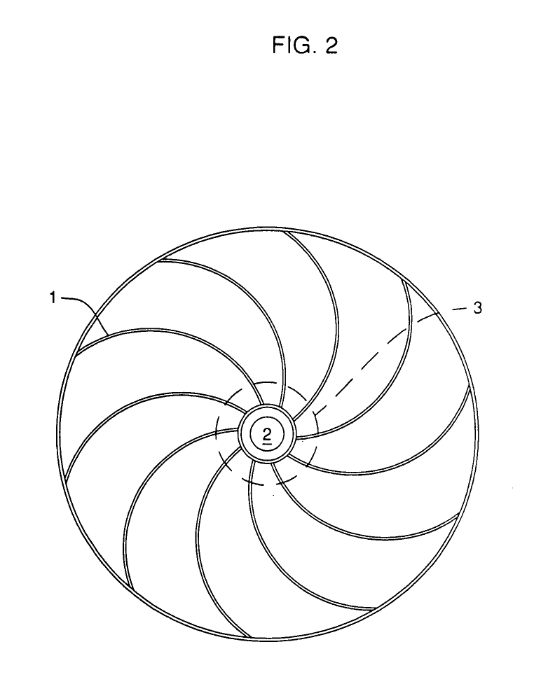

FIG. 2 depicts a front view of the impeller design. Blades radiating from the central hemispherical shaft show increasing pitch and depth. #1 are the impeller blades. #2 is the central axle for the impeller assembly. #3 indicate the location of the magnetic clutch.

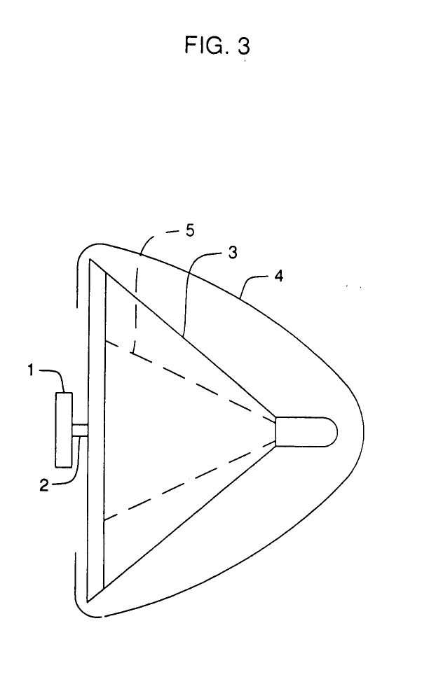

FIG. 3 illustrates a side view of the impeller assembly. #1 is the magnetic clutch. #2 is the central axle. #3 is the impeller. #4 shows the protective screen. #5 illustrates the increasing depth of the impeller blades.

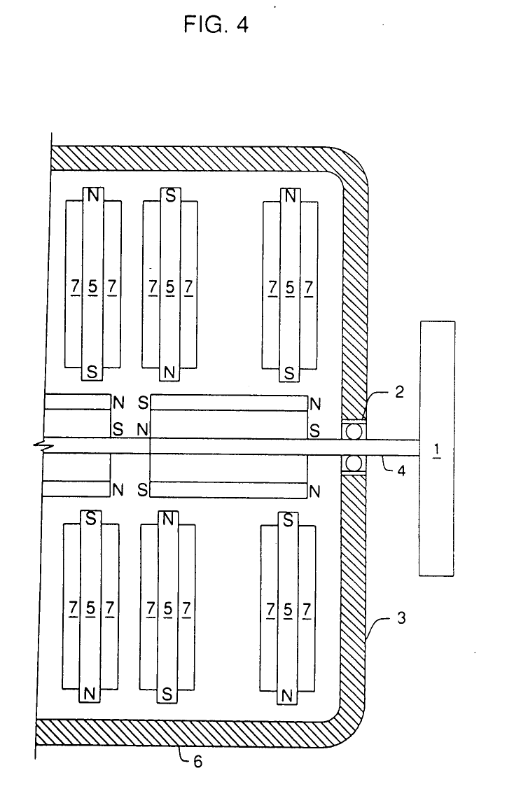

FIG. 4 illustrates a side view of the alternator/generator, although a conventional alternator/generator can be used. FIG. 4 illustrates the replacement of the conventional laminated iron poles with high fluxivity permanent magnets. These are placed radially to the permanent magnet brushless rotor. The wire coils into which the current is induced are wound directly onto these pole piece magnets. These oils can be wound with a taper to conform to the geometry of the space between the neighboring pole piece magnets, hence increasing the number of coil windings to produce more current. #1 is ½ of the magnetic clutch assembly. #2 is the end bearing of the alternator. #3 is the end bell of the casing. #4 is the central axle of the alternator. #5 are the high output permanent magnets of the stator. #6 is the alternator housing. #7 are the wire windings around the stator pole pieces.

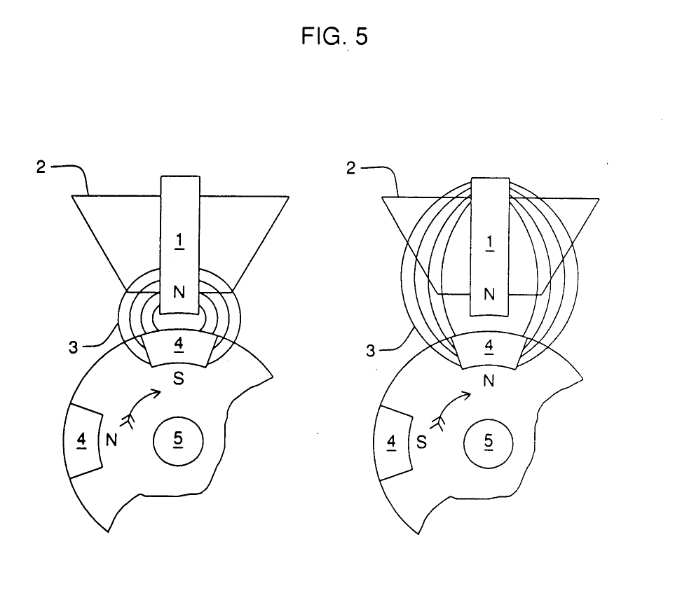

FIG. 5 is a schematic depiction of the changes in the magnetic flux around the stator field coils. #1 are the stator magnets. #2 are the generating coils wound onto the stator magnets. #3 illustrates the magnetic flux lines. #4 are the rotor magnets. #5 is the rotor axle.

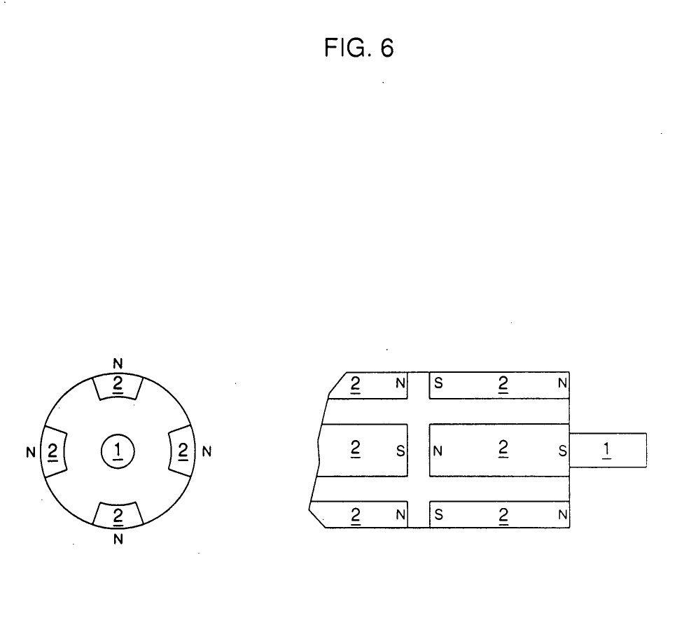

FIG. 6 is a schematic drawing of the rotor. #1 is the axle. #2 shows the placement of the magnets and their polarity. Although four magnets are shown, there is no limitation to the number of magnets except for physical size.

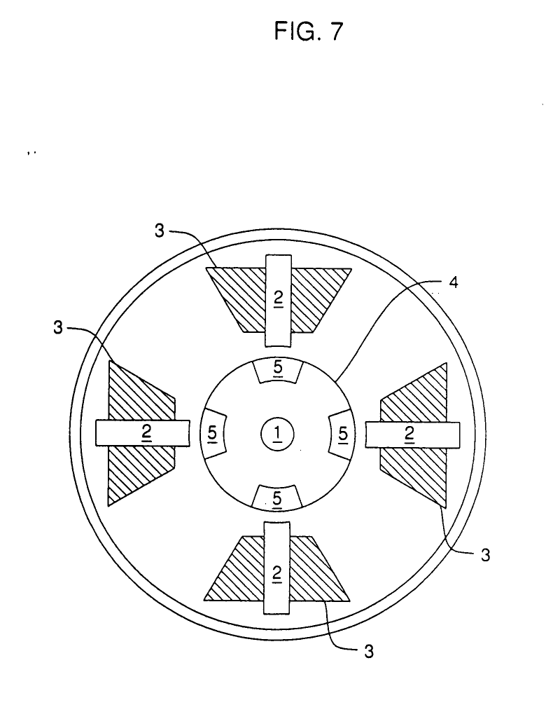

FIG. 7 is a schematic cross section view of the alternator/generator. #2 is the axle. #2 shows the stator magnets. Although four are shown, the number of these magnets is determined by physical size. #3 are the wire coils wound around the magnets into which is induced the electrical energy. These are connected into whatever configuration is desired as far as the output. #4 is the rotor. #5 indicates the rotor magnets.

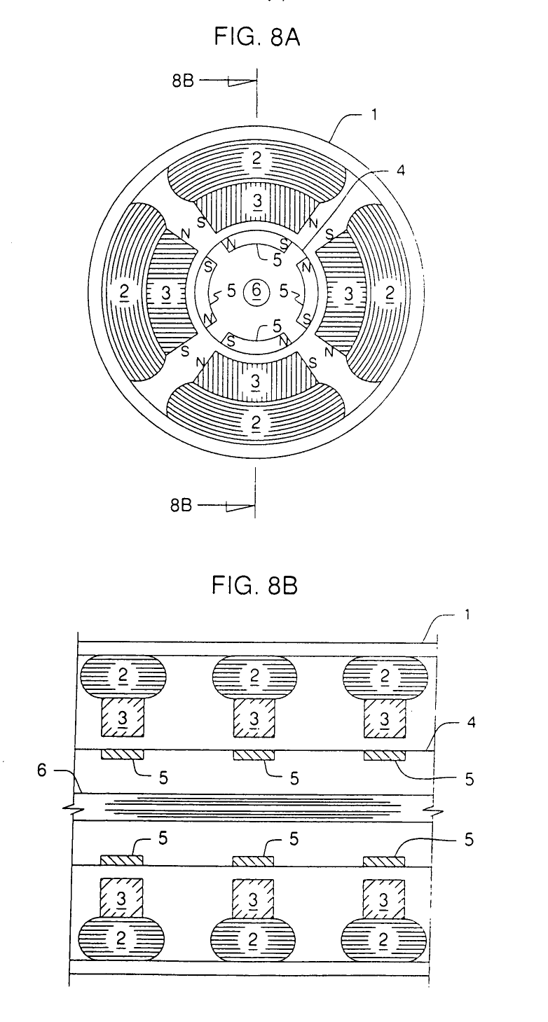

FIG. 8 depicts a radial magnetic arrangement as an alternate system wherein the stator coils are mounted above the permanent magnets. #1 is the alternator/generator frame. #2 are the stator coils. #3 are the stator permanent magnets. #4 is the rotor. #5 are the rotor permanent magnets. #6 is the rotor axle.

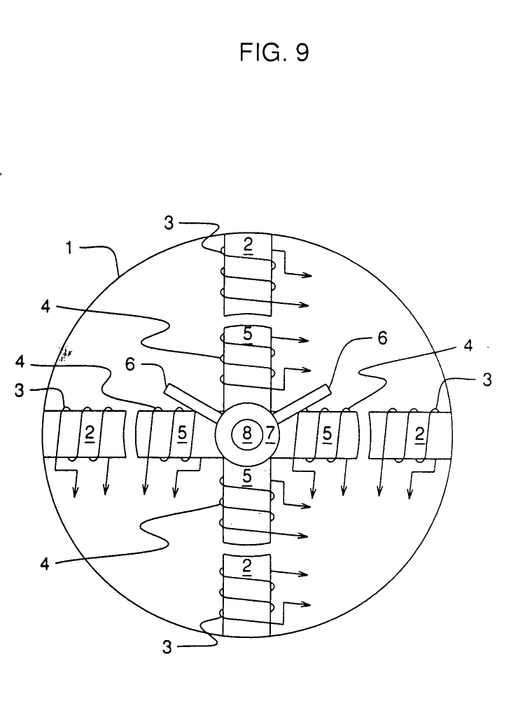

FIG. 9 illustrates a radial view of a bi-wound alternator/generator wherein both stator and rotor permanent magnets have induction coil windings. #1 is the alternator/generator housing. #2 are the permanent magnet pole pieces. #3 are the stator coil windings. #4 are the rotor windings. #5 are the stator permanent magnets. #6 are the brushes. #7 are the commutator rings. #8 is the rotor axle.

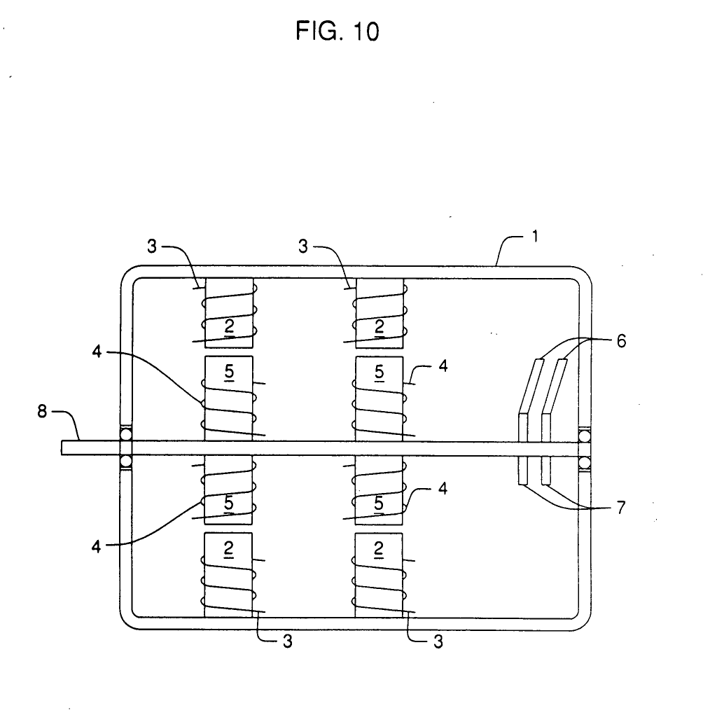

FIG. 10 shows an axial view of a bi-wound alternator/generator. #1 is the housing. #2 are the permanent magnet pole pieces. #3 are the stator windings. #4 are the rotor windings. #5 are the rotor permanent magnets. #6 are the brushes. #7 are the commutator rings. #8 is the rotor axle.

What is claimed is:

1) an impeller of such design as to maximize the mechanical force of flowing water and to convert this energy into a rotary mechanical motion.

2) a suitable safety screen around the impeller to divert any solid and floating materials from coming into contact with the rotating impeller.

3) a magnetic clutch to transmit the rotational energy from the impeller to the alternator/generator through a waterproof barrier.

4) a totally sealed alternator/generator housing which can be filled with dry nitrogen or inert gasses before being sealed.

5) a totally sealed alternator/generator housing into which a desiccant is inserted prior to sealing.

6) fins which both direct the device into the water current as well as acting as a heat sink to dissipate generated heat into the surrounding water.

7) a mounting with rotating bearings which allows the alternator/generator and impeller assembly to rotate through a prescribed arc.

8) a system for generating electricity by forcing a fixed magnetic field into oscillation from the rotating force of attracting and opposing rotor magnets.

9) a system for generating electricity where both rotor and stator magnets have windings, either around each permanent magnet or in close proximity to each magnet, the magnetic force fields thus crossing the coils to produce an electrical current.
